(19) United States
(12) Patent Application Publication
(10) Pub. No.: US 2008/0030091 A1
(43) Pub. Date: Feb. 7, 2008

(54) HYSTERESIS CLUTCH/BRAKE

(75) Inventors: Stefan Unseld, Weissensberg (DE); Konrad Thoma, Friedrichshafen (DE)

Correspondence Address: DAVIS BUJOLD & Daniels, P.L.L.C., 112 PLEASANT STREET, CONCORD, NH, 03301, US

(73) Assignee: ZF FRIEDRICHSHAFEN AG, Friedrichshafen (DE)

(21) Appl. No.: 11/773,603

(22) Filed: Jul. 5, 2007

(30) Foreign Application Priority Data
Jul. 6, 2006 (DE) 10 2006 031 310.0

(51) Int. Cl. H02K 49/04; H02K 49/10

(52) U.S. Cl. 310/106

(57) ABSTRACT

A hysteresis/brake having a magnetic body (2) with an inner pole ring (4), an outer pole ring (6) and an anchor (7) with a permanently magnetic hysteresis ring (9). The hysteresis/brake further includes at least one intermediate pole ring (5, 13) radially located between the inner pole ring (4) and the outer pole ring (6). The anchor (7) additionally includes further hysteresis ring (8, 14) for each intermediate pole ring (5, 13). The hysteresis rings (8, 9, 14) are arranged in such a way that each hysteresis ring is magnetically permeated by the magnetic field between two different pole rings (4, 5, 6, 13).

This application claims priority from German Application Ser. No. 10 2006 031 310.0 filed Jul. 6, 2006.

### FIELD OF THE INVENTION

The present invention relates to a hysteresis clutch/brake.

### BACKGROUND OF THE INVENTION

Hysteresis clutches and hysteresis brakes are known in many versions. They display the advantage of contact-free torque transfer, via an air gap. The functioning of hysteresis clutches, or as the case may be, hysteresis brakes generally depend on the magnetic force of mutually attracting poles in synchronization, or as the case may be, on constant remagnetization of a hysteresis material that is moved past these poles in a slip operation.

Hysteresis brakes are particularly suitable for use as retarders for the processing of material on a manufacturing line, such as, for example, stranding, thread production, etc. The equipment defines the speed at which the material is drawn off the bobbin, whereby the retarder defines the tension. For this purpose, the material from the supply is carried in the appropriate manner via a roller, for example in that it wraps around the roller, whereby the roller transfers the braking action of the hysteresis brake to the material.

Hysteresis clutches and brakes are known, for example, from DE 39 05 216 C2, DE 199 17 667 A1, and DE 37 32 766 A1 of the applicant, whereby the transferable torque can be adjusted depending on the current flowing through the armature and field coil.

DE 39 05 216 C2 of the applicant describes an electrically controlled hysteresis clutch, whereby the transferable torque is adjustable depending on the current flowing through an armature and field coil. The hysteresis clutch, which operates according to the generally known principle, is executed without carrier-wheel center rims of spool cage and pole ring, so that the spool directly encloses the drive shaft made of magnetizable material, with only a small gap.

The pole ring and anchor are hereby located axially downstream from the spool housing, and the spool is longitudinally extended. This produces such a small external diameter in the clutch components, that they can, if necessary, be completely inserted into an internal hollow space of the drive shaft, concentrically to the drive shaft. This also enables later installation of hysteresis clutches between existing axle supports, allowing for less use of material, because no additional axial installation space is required.

DE 199 17 667 A1 of the applicant describes an electromagnetic hysteresis unit with magnetic north poles that are assigned to magnetic south poles, alternating with them at intervals around a rotational axis in the circumferential direction on a magnet body comprising a magnetic coil. In this way, a hysteresis ring, connected with a rotor, can be moved with a slight play toward the poles. In the case of this hysteresis unit, the peripheral surfaces of the north poles and the south poles lie within the same orbit and opposite the same peripheral surface of the hysteresis ring, which provides for radial installation space to embed the hysteresis ring in the rotor made of material that conducts heat well and, as the case may be, provides for cooling fins.

A permanently energized hysteresis clutch is known from the applicant's DE 37 32 766 1, whose transferable torque can be modified by means of a manual change in the immersion depth of a hysteresis ring body in an air gap formed between two pole rings of a permanent magnet. The hysteresis clutch known from DE 37 32 766 A1 features a hysteresis component configured as a bell rotor and an energizing component consisting of an inner and an outer ring, whereby the magnetic pole is assigned to both generated surfaces of the bell rotor. The pole rings hereby consist of magnetically soft material and pieces of permanent magnet that are completely embedded in the magnetically soft material, so that the magnet poles facing the bell rotor are formed alternately by the permanent magnet and the soft magnet. In addition, the inner and outer pole rings are fixedly connected, but magnetically separated by a non-magnetizable intermediate ring. The pole rings are aligned so that from the outer to the inner pole ring, the same poles always radially face each other.

Because torque transfer takes place without contact in hysteresis systems, the ratio of transferable torque to required installation space is significantly less favorable in the known hysteresis systems than in clutches and brakes with form or frictionally engaging power transmissions.

### SUMMARY OF THE INVENTION

The aim of the presented invention is to provide a hysteresis clutch/brake, in which the relation between torque and installation space is significantly improved compared to the current state of the art.

A hysteresis clutch/brake is proposed, which comprises a magnet body with an inner pole ring and an outer pole ring, as well as an anchor consisting of permanently magnetic material, with a permanently magnetized hysteresis ring, in which an inner pole ring is arranged, in a radial sense, between the inner pole ring and the outer pole ring, whereby the anchor for each inner pole has an additional hysteresis ring, whereby the hysteresis rings are arranged in such a way that each magnetic ring is magnetically permeated by the magnetic field between two different pole rings. The magnet body can feature a field coil or can be constructed as permanently magnetized.

Displacement between the poles in the circumference direction forces a tangential increase in the magnetization of the hysteresis material; a resistance counteracting a rotary motion of the anchor is created, which is dependent on the energy required for the magnetization reversal. In that way, a shaft connected in a rotationally fixed manner with the anchor can be braked, for example.

With the inventive concept, the energy of the magnetic circuit of the hysteresis clutch/brake is better utilized through the corresponding configuration of the magnetic circuit with double or multiple arrangements. In particular, through the special arrangement of one or more inner pole rings and the corresponding use of two or more permanently magnetized hysteresis rings, the magnetic field according to the present invention will be better utilized, and due to the significantly higher remagnetization energy required by this, a significantly higher, transferable torque will be achieved in the same installation space.

### BRIEF DESCRIPTION OF THE DRAWINGS

The invention is explained below in more detail on the basis of examples using the attached figures. They show:

FIG. 1 is a schematic cross section of a hysteresis clutch according to the invention;

FIG. 1A is a top view of the hysteresis clutch according to FIG. 1;

FIG. 2 is a schematic cross section of another embodiment of a hysteresis brake according to the invention;

FIG. 2A is a top view of the embodiment of the hysteresis brake according to FIG. 2;

FIG. 3 is a schematic presentation of the magnetic flow in the case of a twofold arrangement of the hysteresis rings;

FIG. 4 is a schematic top view of an embodiment of the inner pole ring of a twofold arrangement of the hysteresis rings, including a presentation of the magnetic flow;

FIG. 5 is a schematic sectional view of an anchor, comprising two hysteresis rings according to the invention;

FIG. 5A is a front view of the anchor, comprising two hysteresis rings according to FIG. 5; and

FIG. 6 a schematic top view of a possible arrangement of the inner pole rings and the hysteresis rings with a threefold arrangement of the hysteresis rings.

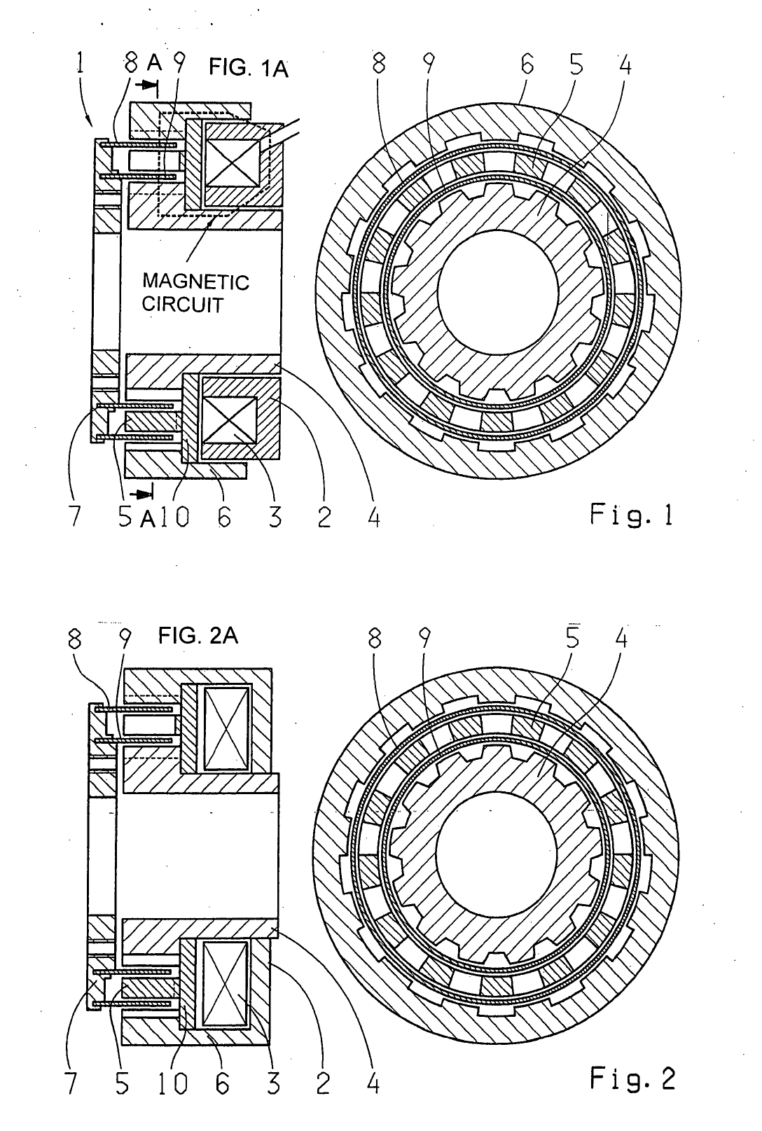

With reference to FIGS. 1 and 1A, in which the right section of a top view is a section along the line A-A: comprising an inventive hysteresis clutch/brake 1, a magnet body 2 with a field coil 3, an inner pole ring 4, an intermediate pole ring 5, and an outer pole ring 6. In addition, the hysteresis clutch/brake 1 comprises an anchor 7 consisting of permanently magnetic material with two permanently magnetic hysteresis rings 8, 9, whereby the hysteresis rings 8, 9 are arranged in such a way that each hysteresis ring 8, 9 is magnetically permeated by the magnetic field between different pole rings. The magnetic circuit is illustrated by the dashed line in FIG. 1A.

In the example shown, the hysteresis ring 8 is permeated by the magnetic field between the external pole ring 6 and the intermediate pole ring 5; the hysteresis ring 9 is permeated by the magnetic field between the intermediate pole ring 5 and the inner pole ring 4. The pole rings 41 5, 6 are connected by a non-magnetizable ring 10.

The embodiment, shown in FIGS. 2 and 2A, differs from the embodiment according to FIGS. 1 and 1A, in that the magnet body 2 and the outer pole ring 6 are integrated into a component.

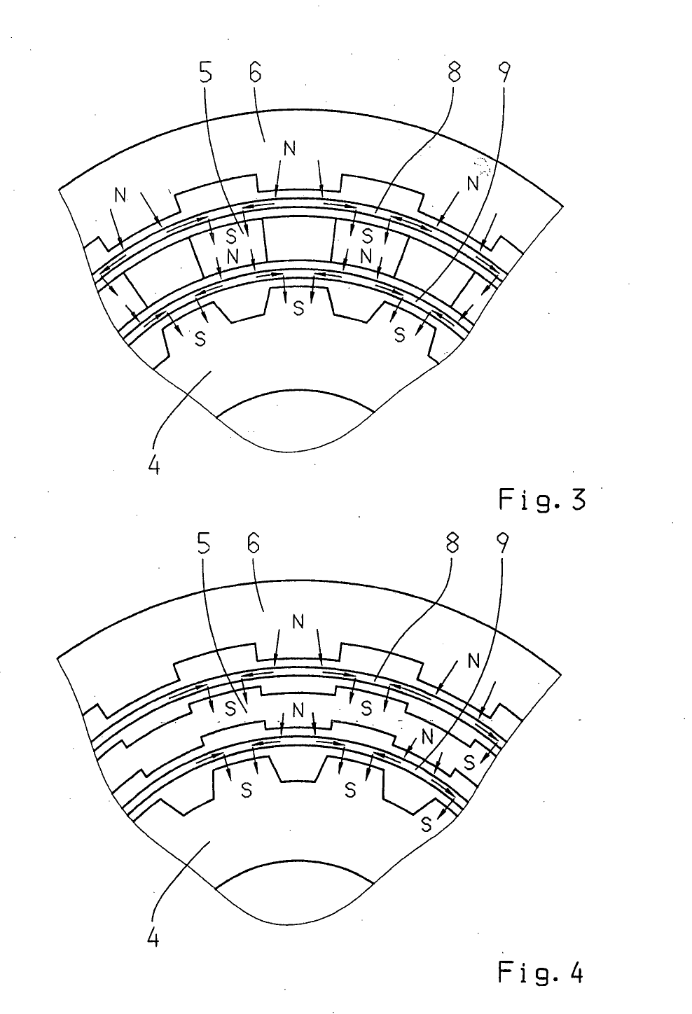

FIG. 3 is a detailed view of the arrangement of the pole rings 5, 6, and 7 shown in FIGS. 1 and 2, and the hysteresis rings 8, 9 in order to illustrate the magnetic flow. This is illustrated by means of the arrows. In this form of embodiment, the poles of the pole rings are arranged in such a way that from the inner to the outer pole ring, opposite poles face each other radially. The outer pole ring 6 is configured as a ring with inward-pointing cogs, seen radially, which form the poles; and the inner pole ring 4, seen radially, is configured as a ring with cogs pointing outward and forming the poles; the intermediate pole ring 5 is configured as a ring with alternating dipoles and gaps arranged in the direction of rotation. As can be seen from the figure, the cogs of the outer and intermediate pole rings are arranged in such a way that seen radially, cogs, or as the case may be gaps, face each other.

Alternatively, the poles of the pole rings can be arranged in such a way that from the inner to the outer pole ring, the same poles face each other radially. This arrangement is the subject of FIG. 4, which presents a top view of an arrangement of the intermediate pole rings. In the example shown in FIG. 4, the inner pole ring 5 is configured as a ring with alternating opposite poles arranged in the direction of rotation, whereby the north poles are formed, seen radially, by cogs pointing inward, and the south poles, seen radially, by cogs pointing outward.

Another difference compared to the embodiment shown in FIG. 3 is seen in that the intermediate pole ring 5 is arranged out of phase relative to the outer pole ring 6, seen radially, so that the cogs of the inner pole ring 4 are opposite to the gaps of the outer pole ring 6. The magnetic flow determined by this arrangement is illustrated by the arrows (electric flux line).

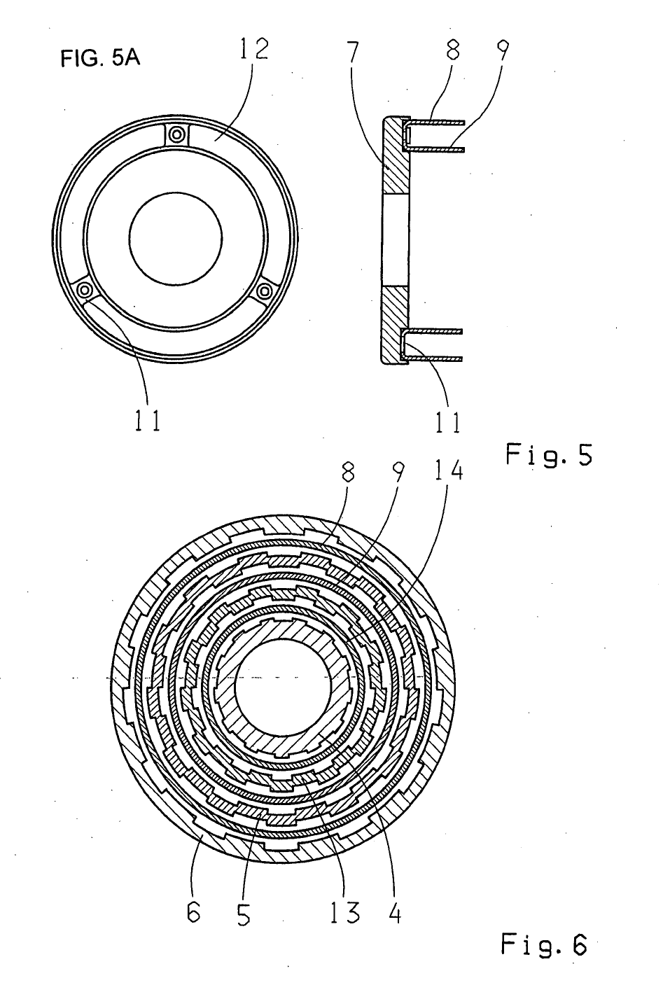

The hysteresis rings 8, 9 can be configured as separate components or as one piece. In the figures shown in FIGS. 5 and 5A, the hysteresis rings 8, 9 are formed from one broad ring, whereby a punched-out area 12 is provided as magnetic separation between the two rings 8, 9. The areas that are not punched out form connection bridge 11 between the rings 8, 9, whereby the connection bridge is advantageously small in size, in order to keep the magnetic connection between rings 8, 9 as small as possible. The connection to anchor 7 can take place via the connection bridge 11, which can, for example, be a screw fitting.

The cost of production is reduced by the one-piece configuration of the rings 8, 9.

Alternatively, the rings 8, 9, can be produced as separate components, which are then connected via non-magnetic connection bridges 11.

FIG. 6 presents another embodiment of an inventive hysteresis clutch/brake, in which two intermediate pole rings 5, 13 are arranged radially between the outer pole ring 6 and the intermediate pole ring 4. According to the invention, the anchor for each inner pole ring also features a further additional hysteresis ring, so that three hysteresis rings 8, 9, and 14 are provided. Each hysteresis ring 8, 9, 14 is magnetically permeated by the magnetic field between the two different pole rings.

The described inventive solution for increasing the torque/installation space ratio can be used for both electromagnetically energized hysteresis clutches and hysteresis brakes and for the correspondingly permanently magnetized systems.

By means of the invention, the “torque intensity” of a hysteresis clutch or a hysteresis brake is increased in an advantageous manner; in addition, by using multiple anchor rings in a suitable arrangement, the allowable slip power of the entire system can be significantly increased.

Every constructive design, in particular every spatial arrangement of the components of the inventive hysteresis clutch/brake as such, and in relation to each other, and insofar as is technically expedient, falls under the scope of protection of the above claims, without affecting the function of the hysteresis clutch/brake as specified in the claims, even when these designs are not explicitly presented in the figures or description.

### REFERENCE SIGNS

1 Hysteresis clutch/brake
2 Magnet body
3 Field coil
4 Inner pole ring
5 Intermediate pole ring
6 Outer pole ring
7 Anchor
8 Hysteresis ring
9 Hysteresis ring
10 Non-magnetizable ring
11 Connection bridge
12 Punched area
13 Intermediate pole ring
14 Hysteresis ring

1-9. (canceled)

10. A hysteresis clutch/brake comprising a magnetic body (2) with an inner pole ring (4), an outer pole ring (6), an anchor (7), made of a permanently magnetized material, with a permanently magnetized first hysteresis ring (9), and at least one intermediate pole ring (5, 13), which is radially located between the inner pole ring (4) and the outer pole ring (6), the anchor (7) further includes an additional hysteresis ring (8, 14) for each one of the at least one intermediate pole ring (5, 13), the first hysteresis ring (9) and the at least one additional hysteresis ring (8, 14) are located such that each of the first hysteresis ring (9) and the at least one additional hysteresis ring (8, 14) is magnetically permeated by a magnetic field between two of the inner pole ring (4), the outer pole ring (6) and the at least one intermediate pole ring (5, 13).

11. The hysteresis clutch/brake according to claim 10, wherein the magnetic body (2) is one of a field coil (3) and made as a permanent magnet.

12. The hysteresis clutch/brake according to claim 10 wherein the inner pole ring (4), the outer pole ring (6) and the at least one intermediate pole ring (5, 13) are connected by a non-magnetizable ring (10).

13. The hysteresis clutch/brake according to claim 10, wherein the magnetic body (2) and the outer ring (6) are integrated into a component.

14. The hysteresis clutch/brake according to claim 10, wherein the first hysteresis ring (9) and the at least one additional hysteresis ring (8, 14) are an integral broad ring, having at least one cut out area (12) between the first hysteresis ring (9) and each of the at least one additional hysteresis ring (8, 14) to provide magnetic separation areas, between the first hysteresis ring (9) and each of the at least one additional hysteresis ring (8, 14), not cut out of the broad ring form connection bridges (11) between the first hysteresis ring (9) and each of the at least one additional hysteresis ring (8, 14), and the connection bridges (11) are minimally sized, to minimize any magnetic connection between the first hysteresis ring (9) and each of the at least one additional hysteresis ring (8, 14).

15. The hysteresis clutch/brake according to claim 10, wherein the first hysteresis ring (9) and each of the at least one additional hysteresis ring (8, 14) are separate components connected by at least one non-magnetic connection bridge (11).

16. The hysteresis clutch/brake according to claim 14, wherein the first hysteresis ring (9) and each of the at least one additional hysteresis ring (8, 14) are connected, via the at least one connection bridge (I1), to the anchor (7).

17. The hysteresis clutch/brake according to claim 10, wherein the outer pole ring (6) has a plurality of radially inwardly directed cogs, with each cogs having a first pole;
the intermediate pole ring (5) is a ring with a plurality of dipole sections alternating with a plurality of gaps, radially in a direction of rotation, each dipole section having a radially interior first pole portion and a radially exterior second pole portion;
the inner pole ring (4) has a plurality of radially outwardly directed cogs, with each cogs having a second pole; and
the outer pole ring (6), the inner pole ring (4) and the intermediate pole ring (5) are each arranged such that the first poles of the outer pole ring (4) are radially aligned with the second pole portion of the dipoles sections of the intermediate ring (5) and the first pole portion of the dipoles sections of the intermediate ring (5) are axially aligned with the second poles of the inner ring (4).

18. The hysteresis clutch/brake according to claim 10, wherein the outer pole ring (6) has a plurality of radially inwardly directed cogs, with each cogs having a first pole;
the inner pole ring (4) has a plurality of radially outwardly directed cogs, with each cogs having a second pole;
the intermediate pole ring (5) is a ring with a plurality of first pole sections alternating with a plurality of second pole sections, radially in a direction of rotation,
the outer pole ring (6), the inner pole ring (4) and the intermediate pole ring (5) are each arranged such that the first poles of the outer pole ring (6), the inner pole ring (4) and the intermediate pole ring (5) are radially aligned and the second poles of the outer pole ring (6), the inner pole ring (4) and the intermediate pole ring (5) are radially aligned.
